(19) United States
(12) Patent Application Publication
(10) Pub. No.: US 2006/0222739 A1
(43) Pub. Date: Oct. 5, 2006

(54) Method for processing and/or assembling, the final composition of matter, and the resulting novel design of a stuffed base product and food stuffs and/or inserts to be known as Supreme Gourmet Burgers and Meatballs Stuffs and Wraps; Base Product Pizza Crust and Receptacles; and Food Stuffs and/or Inserts.

(75) Inventor: Vera Anne Kiesling, Jacksonville, AR (US)

Correspondence Address: VERA ANNE KIESLING, 28 EDGEWATER COURT, JACKSONVILLE, AR, 72076, US

(73) Assignee: Vera Anne Arnold, Jacksonville, AR (US)

(21) Appl. No.: 10/907,375

(22) Filed: Mar. 30, 2005

(51) Int. Cl. A23L 1/31

(52) U.S. Cl. 426/92

(57) ABSTRACT

A method is provided for assembling a sealed final composition of matter made from the base product and “food stuffs” and/or “inserts” which may or may not contain a novel design claimed herein. This instant patent will not infringe on any existing patent and specifically exclude any item, method, process, composition of matter, and novel design thereof.

The present invention generally relates to an apparatus and method for assembling a product including “food stuffs” and/or “inserts” between or within one or more “base products” that are fastened together in order to form a “stuffed” base product, and the final composition of matter produced as a result of this method and/or the novel design created while producing the final composition of matter. The present invention also extends to the “food stuffs” and/or “inserts” formed prior to or with the specific purpose of insertion into or between the “base product” or to be inserted into or between the “base product” by any means, by any person, machine, or process.

More particularly, the invention relates to the creation of a “food stuff” and/or “insert” composition of matter to be placed between or within one or more “base products”; an actual method of placing the “food stuffs” and/or “inserts” between or within one or more “base products”; the final composition of matter produced; and/or the design created while producing the “base product.”

Previous attempts have been made to produce proteinaceous products that are filled with other food items such as cheeses and condiments and “knitting” a pleurality of patties in a manner and sandwich-like fashion in which patties may have cheeses, condiment, or the like located there between similar to building a multi-layered, multi-pattied burger such as a double cheeseburger. Such prior attempts frequently produced a final product with a bulge in the center which would not necessarily cook evenly. Generally speaking, such prior approaches do not produce a flat, symmetrical final composition of matter which cooks evenly throughout.

Generally speaking, such prior approaches do not place a “food stuffs” and/or “insert” on or within: 1.) a single “base product” to be covered by more base product and shaped to form a single final composition of matter; or 2.) an indention in a “base product” covered by a second or pleurality of base product which are then fastened.

A second or pleurality of “base product” may be of a desired pitch and flat in form and/or may also contain as indention that will fit over the “food stuffs” and/or “insert.” The final composition of matter should appear as a flat, symmetrical final product so as to cook evenly throughout. Rather than proceeding with a general approach that involves assembling “food stuff” and/or “insert” in or within one or more base products and fastening the base product together to form a flat, symmetrical composition of matter, such previous attempts at preparing stuffed proteinaceous patty products have been more in the nature of actually stuffing condiment material into an opening within a meat item or “knitting” a pleurality of proteinaceous patties together with cheeses, condiments, and the like between the patties to form a final product with a bulge in the center. Such a “knitting” process would merely form a bond connecting the proteinaceous patties without necessarily remaining the contents within a sealed final composition of matter which will not leak without being punctured, bit, cut, torn, or the integrity otherwise altered.

Contrary to this, the present invention includes the basic approach of building or assembling a final product in a sandwich like fashion wherein the “food stuff” and/or “insert” or otherwise inserted on or within: 1.) a single “base product” to be covered by additional “base product” and shaped to form a single final composition of matter; 2.) by wrapping or applying base product around rods or logs of food stuff and/or inserts, slice into patties of desired size, shape, and pitch; and fasten base product to the top and bottom of these base product-food stuff and/or insert patties to form a final composition of matter, after which the various components are fastened together; 3.) a indention in a “base product” covered by a second or pleurality of base product which are then fastened to form a sealed final product which will not leak without being punctures, bit, cut, torn, or the integrity otherwise altered;

For increased binding properties, the “pressurized fastening device” may apply an uniform or other pattern on, near, and/or around the outer perimeter or circumference of the base product so as to displace and fasten the base product together while shaping it to form a single sealed final composition of matter, referred to herein as Supreme Gourmet Burger and/or Meatball Stuffs and Wraps. This method and step will be accomplished by “displacing teeth” or any other “displacing design” attached to, part of, or separate from the “pressurized fastening device”, referred to as “displacing teeth and/or design.” While this step is recommended, it is not required to produce the final sealed composition of matter referred to as Supreme Gourmet Burger and/or Meatball Stuffs or any part thereof.

To prevent the flattening, squashing, and/or any change in the original diameter of the base product during the intention or fastening process, an “intention device form/sleeve” [claims 8, 9, and 10] and/or a “fastening device form/sleeve” [claims 11, 12, 13, and 14] of desired shape and size may be lowered over and/or placed around the base product prior to or while applying the “pressurized fastening device” of desired shape and size and/or any other method of fastening including air. While this step is recommended to maintain the shape of the product, it is not required to produce the final sealed composition of matter.

Additionally, the present invention includes the basic approach of building, assembling, and/or producing a final product/composition of matter by rolling, wrapping, and/or folding a sheet of base product over and/or around a strategically placed “food stuff” and/or “insert(s)” to form a final composition after which the various components are fastened and further cooked or otherwise prepared.

Additionally, the present invention includes the basic approach of building, assembling, and/or producing a high protein and low carbohydrate pizza crust by shaping base product into a desired size and shape of pizza crust in place of the normal bread crust and cook as desired to form a final composition of matter after which various pizza components are placed and further cooked and otherwise prepared. A large slice of pepperoni would be an ideal base product for this method and final composition of matter.

Additionally, the present invention includes the base approach of building, assembling, and/or producing a final product/composition of matter by shaping the base product into a bowl or receptacle of desired shape and size and to cook or otherwise prepare this base product after which various pizza components and, if necessary, further cooked. A large slice of pepperoni would be an ideal base product for this method and final composition of matter.

The following apparatus and/or concepts incorporated into the listed methods of production include, but are not limited to: “food stuffs” and/or “inserts,” base product, fastening of base product through various methods, an indention in the base product, a “pressurized indention device,” an “indention device form/sleeve,” “pressurized fastening device,” “displacing teeth or design,” “fastening device form/sleeve,” the distinct and novel design of the final sealed composition of matter referred to as “Supreme Gourmet Burger and Meatball Stuffs and Food Stuffs and/or Inserts,” and any part thereof, and specific examples of the final composition of matter.

When stuffed, wrapped, and fastened, Supreme Gourmet Burger and Meatball Stuffs and Wraps and “Food Stuffs” and/or “Inserts” of this type are to be assembled and processed under high volume or industrial-type conditions, it is important to be able to accomplish the assembly steps on a continuous basis and in a manner in which the assembled product that is produced is of consistent quality and appearance. Another important consideration is the ability to provide an overall industrial-type line that has individual components which are readily accessible for maintenance needs and also for cleaning operations that are essential for industrial-scale food processing lines. Also important is the ability for such a line to readily handle large volumes of products, preferably on a continuous basis such that products in differing stages of assembly are simultaneously undergoing respective ones of various assembly procedures while the respective products or partially formed products are being conveyed.

In the instant patent, one of more of the various assembly steps can be chronologically arranged at various operational stations for an orderly, efficient, and cost-effective assembly of the final composition of matter.

Basic objectives of this type, as well as additional specific advantages and features, are achieved according to the present invention, which includes a plurality of operational stations that are chronologically spaced along a conveyor assembly, which operational stations perform desired respective functions, including depositing various “food stuffs” and/or “inserts” onto the conveyor or a “food stuff” and/or “insert” that has been previously deposited onto the conveyor or onto another such food item or layer ultimately supported by the conveyor in order to thereby form a multi-layered food product on the conveyor. A further operational station maybe provided for fastening at least some of these layers to each other in order to form an assembled product having generally unitary characteristics referred to as Supreme Gourmet Burger and Meatball Stuffs and Wraps. The production of “food stuffs” and/or “inserts” without actual placement into the base product requires fewer steps and essentially no fastening is required prior to packaging as a “food stuff” and/or “insert.”

It is accordingly a general object of the present invention to provide an actual and/or approved apparatus and method for producing and/or assembling Supreme Gourmet Burgers and Meatball Stuffs and Wraps and “food stuffs” and/or “inserts” and the resulting novel design.

Another object of the present invention is to provide an actual and/or approved apparatus and method associated with an industrial-scale food processing line whereby a multi-layered food product is produced and/or assembled into a generally unitary product having external layers of the “base product” and at least one internal “food stuff” and/or “insert.”

Another object of this invention is to provide an actual and/or improved apparatus and method for continuously conveying a food product at various stages of production and/or assembly thereof, with a plurality of stations performing desired operations on the product at various stages of its production and/or assembly and while same continues to be conveyed there along.

Another object of this invention is to provide an actual and/or improved apparatus and method including a plurality of stations that are properly sequenced and timed to accurately accomplish depositing, assembling, producing, and fastening functions.

Another object of this invention is to provide an actual and/or improved apparatus and method for depositing discrete “food stuffs” and/or “inserts” onto desired locations along a moving conveyor and in accordance with a predetermined pattern.

Another object of this invention is to provide an actual and/or improved apparatus and method which includes the ability to cyclically impart fastening motion to a flow of multi-layered Supreme Gourmet Burgers and Meatball Stuffs and Wraps, and Base Product Pizza Crust and Receptacles in order to thereby fasten such items together.

Another object of the present invention is to provide an actual and/or improved apparatus and method which includes producing and/or assembling a multi-layered Supreme Gourmet Burger and Meatball Stuffs and Wraps and “Food Stuffs” and/or “Inserts” including a product with one or more “Food Stuffs” and/or “Inserts” included there between and the actual “Food Stuffs” and/or “Inserts.”

Another object of this invention is to provide an actual and/or improved apparatus and method for automatically producing and/or assembling in an economically feasible manner a product that is difficult to manufacture manually.

These and other objects, features and advantages of this present invention will be clearly understood through a consideration of the following detailed description.

### BRIEF DESCRIPTION OF THE DRAWING

The attached drawings are not drawn to scale and are made for understanding this patent's claims. Variations will be made so as to economically manufacture the final composition of matter.

In the course of this description, reference will be made to the attached drawings, wherein:

FIGS. 1A and 1B, provide a top view of; (FIG. 1A) a horizontal cross-section of the final composition of matter; (FIG. 1B) a possible novel design of the final composition of matter.

FIGS. 2A and 2B, provide a bottom view (FIG. 2A) and a side-view (FIG. 2B) of a pressurized indention device.

FIGS. 3A and 3B, provide a side-view illustration of a pressurized indention device or a pressurized fastening device (without displacing teeth or design attached) in conjunction with its corresponding Indention Device and/or Fastening Device Form/Sleeve (FIG. 3A) and a pressure plate with multiple pressurized indention devices attached (FIG. 3B) for industrial scale production of product.

FIGS. 4A and 4B, provide a top-view (FIG. 4A) and a side-view (FIG. 4B) of displacing teeth and/or design. FIG. 4A represents the displacing teeth and/or design incorporated into and illustrated in FIGS. 4B, 5A, 5B, 6, 7, and 8. FIG. 4B represents an upper and lower set of interlocking displacing teeth and/or design which produce a novel design in the final composition of matter such as the one illustrated in FIGS. 1B, 7, and 8.

FIGS. 5A and 5B, provide illustrations of how a pressurized fastening device with displacing teeth and/or design is applied to one side of a base product containing the food stuff and/or insert(s) to produce a final composition of matter with a novel design on one side such as the one illustrated in FIG. 1B.

FIG. 6, provides an illustration of an individual indention device and/or fastening device form/sleeve positioned around and attached to its corresponding device which would be used to prevent the flattening, squashing, and/or any change in the original diameter of the base product of the desired final composition of matter.

FIG. 7, provides an illustration of a pressurized fastening device with displacing teeth and/or design and a set of lower interlocking displacing teeth and/or design being applied to two sides of a base product containing the food stuff and/or insert(s) to produce a final composition of matter with a novel design on two sides as illustrated in FIGS. 1A and 1B.

FIG. 8, provides a side-view illustration of a pressurized fastening device with upper and lower interlocking displacing teeth and/or design in conjunction with an unattached fastening device form/sleeve (FIG. 3A) being applied to two sides of a base product containing the food stuff and/or insert(s) to produce a final composition of matter with a novel design on two sides as illustrated in FIGS. 1B and 7.

### DESCRIPTION OF THE PARTICULAR EMBODIMENTS

The attached drawings and illustrations are not drawn to scale and are made for understanding this patent's claims. Variations of size, shape, depth, and pitch will be made so as to economically manufacture the final composition of matter.

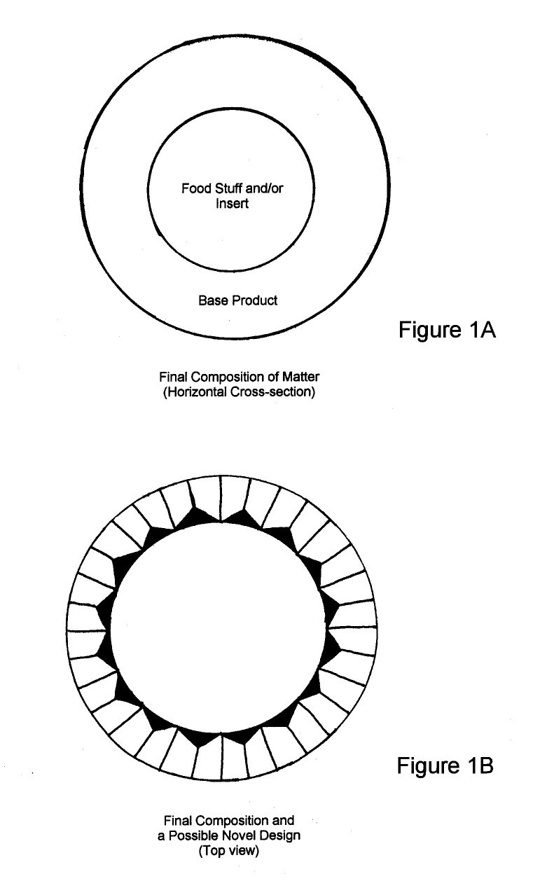

With particular reference to FIG. 1A, it provides a top-view of a horizontal cross-section of the final composition of matter which is subject to the process and other claims described in instant patent. FIG. 1A also represents a slice or horizontal cross-section of the “base product”—“food stuff” and/or insert composition product described in claim 6.

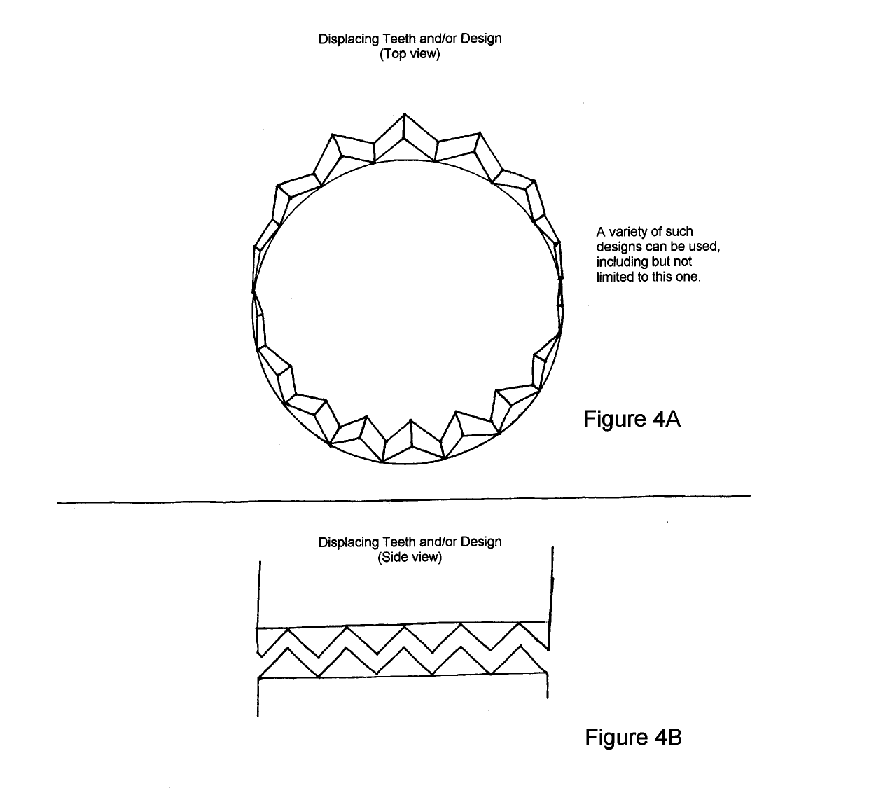

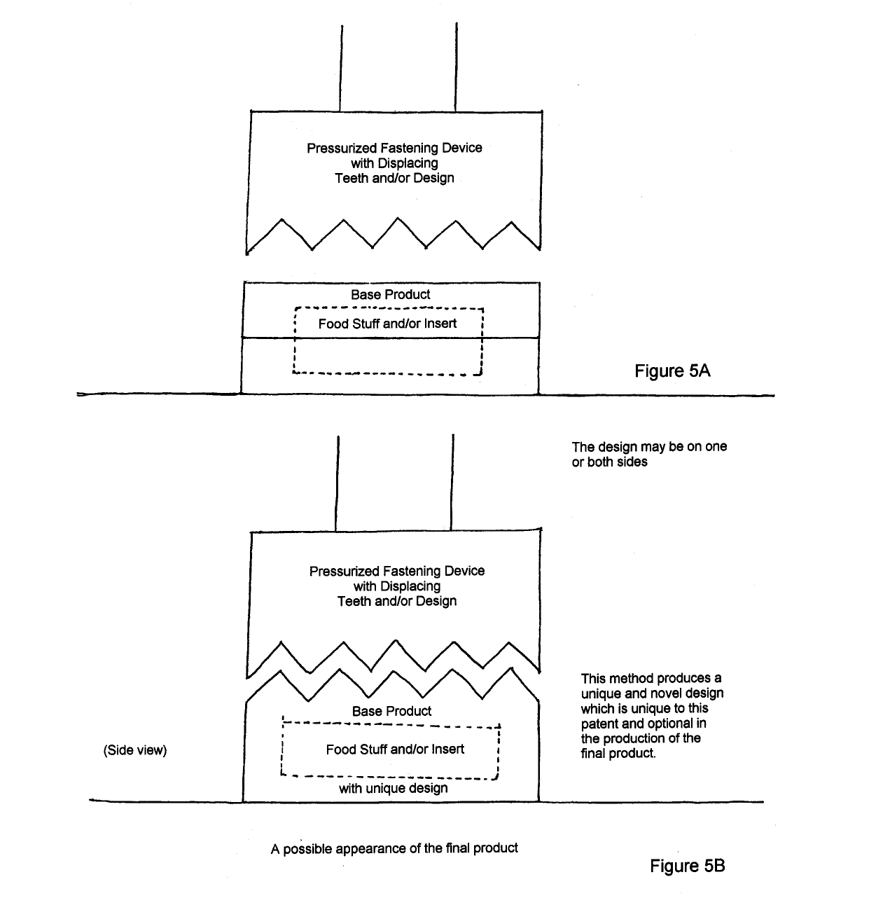

FIG. 1B is a novel design subject to instant patent claims. This design may vary based on preference and/or manufacturing needs. FIGS. 4A and 4B are examples of the displacing teeth and/or design used to create the novel design subject to the claims of the instant patent. FIGS. 5A, 5B, 6, 7, and 8 are illustrative of the instant claims and corresponding processes which produce the novel design subject of FIG. 1B.

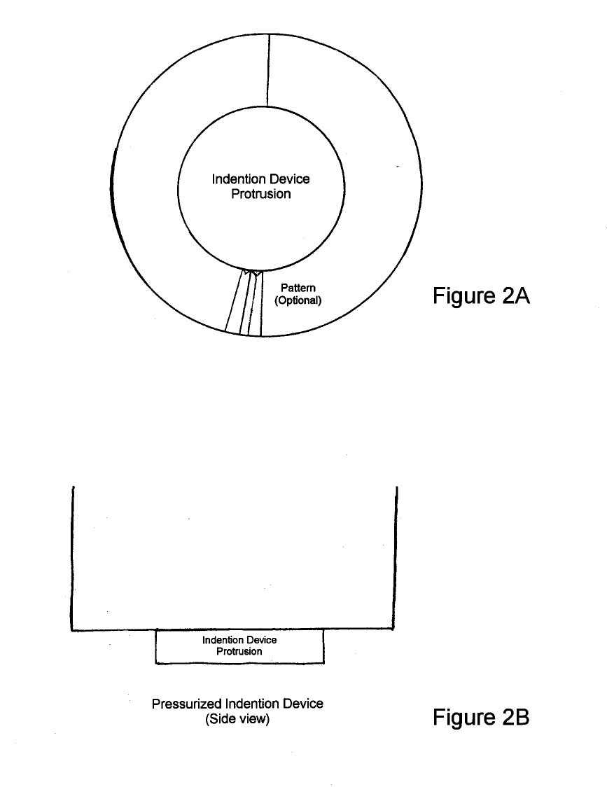

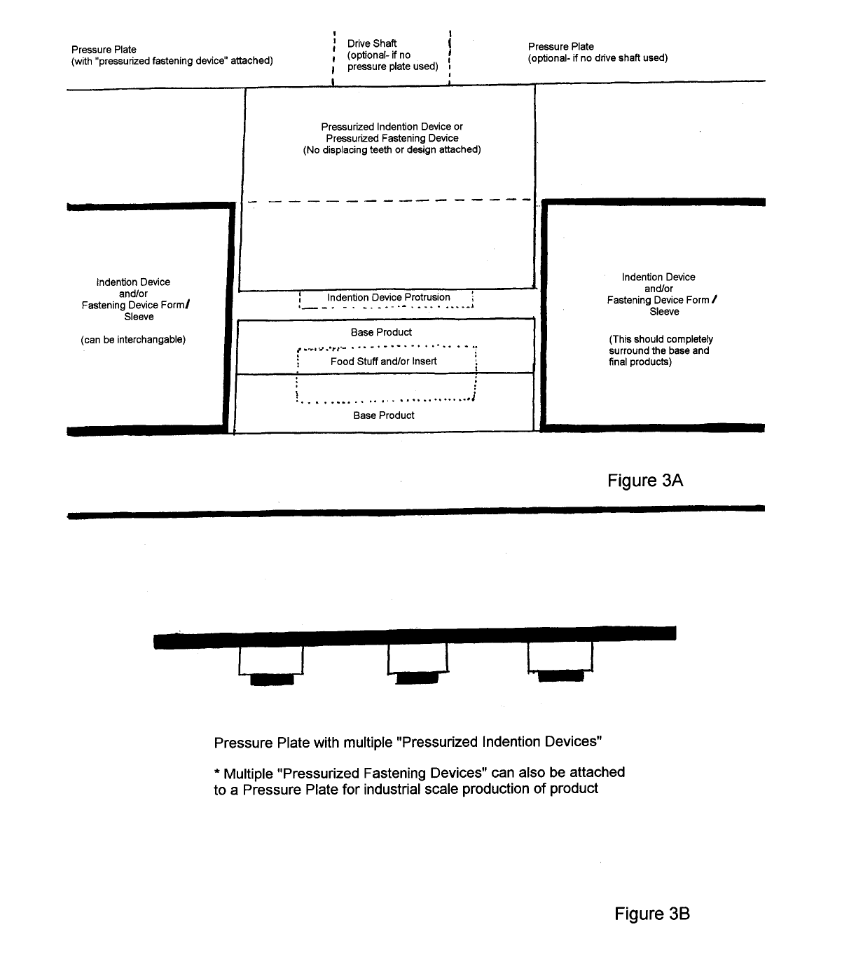

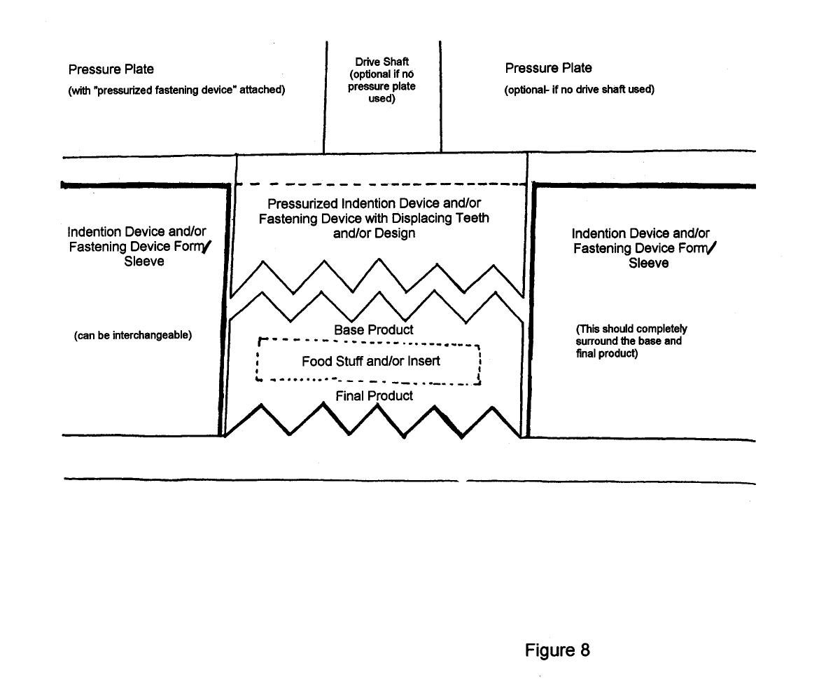

FIGS. 2A and 2B are a bottom view (FIG. 2A) and a side-view (FIG. 2B) of a pressurized indention device with optional uniform, random, and/or rough pattern subject of the instant claims. This device is used to create an indention in base product to place “food stuff” and/or “insert(s),” which is subsequently covered by additional base product subject of instant claims. FIGS. 3A, 3B, and 8 are illustrative of FIGS. 2A and 2B and instant claims.

FIG. 3A, provides a side-view illustration of a pressurized indention device or a pressurized fastening device (without displacing teeth and/or design attached) in conjunction with its corresponding unattached indention device and/or fastening device form/sleeve. The pressurized indention device and/or pressurized fastening device may be individually attached and driven by a driving shaft or attached to a pressurized plate. Multiple pressurized indention devices and/or pressurized fastening devices can be attached to a pressure plate for industrial scale production of product subject of instant claims (FIG. 3B). FIG. 8 is illustrative of FIG. 3A and instant claim.

FIG. 4A, provides a top-view of displacing teeth and/or design subject of instant claims. FIG. 4B, provides a side-view illustration of an upper and lower set of interlocking displacing teeth and/or design which produce a novel design in one or two sides of the final composition of matter. FIGS. 1B, 5A, 5B, 6, 7, and 8 embody the designs illustrative of FIGS. 4A and 4B.

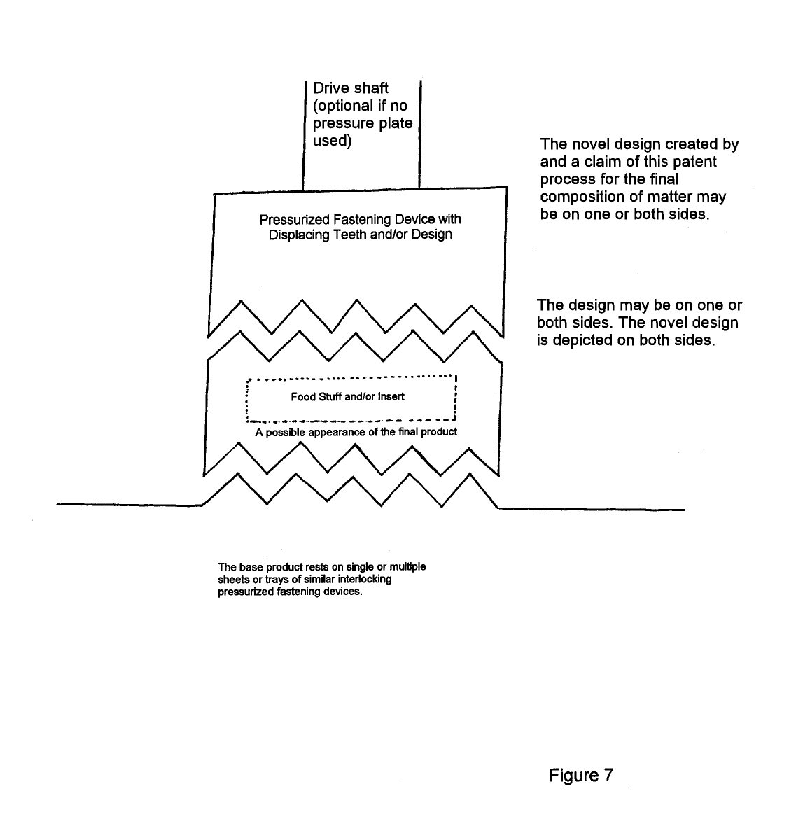

FIGS. 5A and 5B are illustrative of how a pressurized fastening device with displacing teeth and/or design (FIGS. 4A and 4B) is applied to one side of a base product containing the food stuffs and/or insert(s) to produce a final composition of matter with a novel design on one side such as the one illustrated in FIG. 1B. The bottom side (FIG. 5B) of the final composition of matter remains flat without the novel design. The novel design may be applied to two sides as later described in FIGS. 7 and 8.

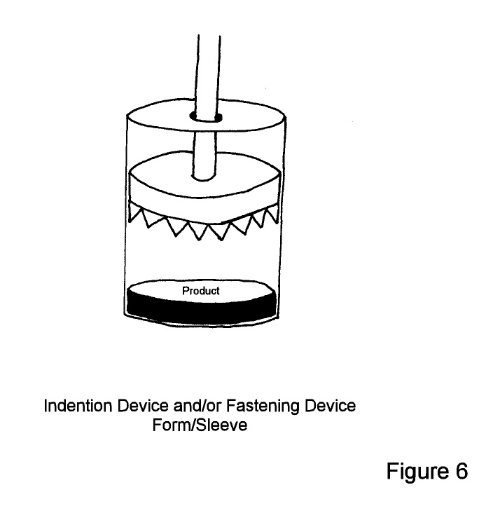

FIG. 6 illustrates as individual indention device and/or fastening device form/sleeve positioned around and attached to its corresponding device which would be used to prevent the flattening, squashing, and/or any change in the original diameter of the base product or the desired final composition of matter. This form/sleeve extends beyond and below the pressurized device and should automatically position itself around the base product, et. al., when lowered. When the form/sleeve rests on the surface around the base product, its movement stops and the pressurized device continues its decent to perform its function subject to the instant claims. The lowering movement of the pressurized device facilitates the movement of the form/sleeve into its desired position around the base product. The raising of the pressurized device lifts the form/sleeve to a raised position when it reaches the top of the form/sleeve.

In the embodiment illustrated in FIG. 7, a pressurized fastening device with displacing teeth and/or design and a set of lower interlocking displaying teeth and/or design being applied to two sides of a base product containing the food stuff and/or insert(s) to produce a final composition of matter with a novel design on two sides as illustrated in FIGS. 1B and 8.

In the embodiment of the side-view illustration in FIG. 8, a pressurized fastening device with upper and lower interlocking displacing teeth and/or design in conjunction with an unattached fastening device form/sleeve (FIG. 3A) being applied to two sides of a base product containing the food stuff and/or inserts to produce a final composition of matter with a novel design on two sides as illustrated in FIGS. 1B and 7.

It will be understood that the embodiments of the present invention and instant claims which have been described are illustrative of some of the applications of the principles of the present invention and claims. Numerous modifications maybe made by those skilled in the art without departing from the true spirit and scope of the invention and instant claims.

What is claimed is:

1. SUPREME GOURMET BURGER AND MEATBALL STUFFS AND WRAPS; BASE PRODUCT PIZZA CRUST AND RECEPTACLES; AND “FOOD STUFFS” AND/OR “INSERTS”.

2. The “base product” consists of a meat or vegetarian burger, patty, or other ground, processed, and/or pressed or crimped substance which contains a mixture of other food items “stuffed” in the center, known as “food stuffs” and/or “inserts,” and the “food stuffs” and/or “inserts” themselves.

3. The “base product” composition shall specifically consist of beef, chicken, turkey, pork, fish, pepperoni, sausage, any proteinaceous substance(s), any single or mixture of vegetarian products (i.e. vegetables, soy, grains, etc.), and any mixture of vegetarian products and/or any proteinaceous substances made in a variety of sizes and shapes (round, square, oblong, cylindrical, etc.) The “base product” shall not consist solely of bread, pasta, and/or other pastry items, but the final composition of matter may be used with a combination of bread, bun, pasta, and/or other pastry item. The “food stuffs” and/or “inserts” will consist of a mixture of food items which are a fresh mixture, a frozen mixture, a liquid mixture, or a previously prepared mixture formed prior to or with a specific purpose of insertion into the “base product” and/or to be inserted into the “base product” by any means by any person, machine, or process.

4. The preferred method for producing a “food stuff” and/or “insert” to be placed in or within the base product will be to:
Freeze a previously prepared mixture into cylindrical, or other shapes, rods or logs of a desired diameter and shape and slice the rods or logs into discs of a desired pitch
Pour a previously prepared mixture into molds and/or forms of a desired size and shape and freeze it if necessary, to maintain the desired size and shape.

5. A method of producing the final composition of matter is to place a “food stuff” and/or “insert” into a single or initial “base product” to be covered by additional “base product” and fastened and shaped to form a single final composition of matter. This can be accomplished by placing an indention of a desired diameter and pitch into the base product, depositing a “food stuff” and/or “insert” with additional base product, fastening the base product together while shaping it to form a single sealed final composition of matter.

6. A method of producing the final composition of matter is to: wrap or apply “base product” around pre-formed rods or logs of “food stuff” and/or “inserts”; slice this base product—“food stuff” and/or “insert” combination products into patties or product of desired shape, size, and pitch; and fasten base product to the top and bottom of these subsequently produced base product—“food stuff” and/or “insert” combination product to form a final composition of matter after which the various components are fastened together.

7. A method of producing the final composition of matter is to place a “food stuff” and/or “insert” on or within an indention in a “base product” covered by a second or pleurality of base product which are then fastened into a sealed final composition of matter. A second or pleurality of base product may be of a desired pitch and flat in form and/or may also contain an impression that will fit over the “food stuff” and/or “insert”. The final composition of matter should appear as a flat, symmetrical final product so as to cook evenly throughout. Rather than proceeding with a general approach that involves assembling “food stuff” and/or “insert” in or within one or more “base products” and fastening the base product together to form a flat, symmetrical composition of matter, such previous attempts at preparing stuffed proteinaceous patty products have been more in the nature of actually stuffing condiment materials into an opening within a meat item or “knitting” a pleurality of proteinaceous patties together with cheeses, condiments, and the like between the patties to form a final product with a bulge in the center. Such a “knitting” process would merely form a bond connecting the proteinaceous patties without necessarily retaining the contents within a sealed final composition of matter which will not leak without being punctured, bit, cut, torn, or the integrity otherwise altered.

8. A method of placing an indention, pattern, or design, in the base product shall include, but not limited to, applying pressure to a cylindrical shaped (or other shaped) device or a device with a cylindrical protrusion (or other shape) of a desired diameter and pitch and forcing it into and thereafter removing it from the base product, thereby leaving as indention of desired shape, size, diameter, and depth whereby the “food stuff” and/or “insert” will be placed. This pressure may be applied manually, mechanically, and/or by any other means. This method and step will be accomplished with a device hereafter referred to as a “pressurized indention device”. For increased binding properties, the pressurized indention device may apply an uniform, random, and/or rough pattern to the remaining base product surrounding the indention. While this step is recommended, it is not required to produce the final composition of matter. To prevent the flattening, squashing, and/or any change in the original diameter of the base product, or the desired final composition of matter, a form or sleeve of desired shape and size may be lowered over and/or placed around the base product prior to or while applying the “pressurized indention device” to the base product. This method and step will be accomplished with a device hereafter referred to as an “indention device form/sleeve.” While this step is recommended, it is not required to produce the final composition of matter.

9. A device referred to as a “pressurized indention device” as described in claims 7 and 8 therein. A pressurized indention device may be used by itself or in conjunction with one or more of the same for mass production. A pressurized indention device(s) as described herein may also be individually or in pleurality incorporated into a large, single or multiple sheet of metal, plastic, or any other substance so as to be economically used for mass production of the final composition of matter or any portion thereof.

10. A device referred to as an “indention device form/sleeve” as described in claim 8 therein. As indention device form/sleeve may be used by itself or in conjunction with one or more of the same for mass production. An indention device form/sleeve as described herein may also be individually or in pleurality incorporated into a large, single or multiple sheet of metal, plastic, or any other substance so as to be economically used for mass production of the final composition of matter or any portion thereof.

11. A method of fastening that shall include, but is not limited to, applying pressure to a device of desired diameter and shape or air pressure onto the additional, second, or pleurality of base product over the single or multiple initial base product, thereby displacing the base product and fastening the final composition of matter together to form a single sealed final composition of matter. This pressure may be applied manually, mechanically, and/or by any other means. This method and step will be accomplished with a device hereafter referred to as a “pressurized fastening device.” For increased binding properties, the “pressurized fastening device” may apply an uniform or other pattern on, near, and/or around the outer perimeter or circumference of the base product so as to displace and fasten the base product together while shaping it to form a single sealed final composition of matter, referred to herein as Supreme Gourmet Burger and/or Meatball Stuffs and Wraps. This method and step will be accomplished by “displacing” teeth or any other crimping/“displacing design” attached to, part of, or separate from the “pressurizing fastening device,” and hereafter will be referred to as “displacing teeth and/or design.” While this step is recommended, it is not required to produce the final sealed composition of matter referred to as Supreme Gourmet Burger and/or Meatball Stuffs and Wraps. To prevent the flattening, squashing, and/or any change in the original diameter of the base product, a “fastening device form/sleeve” of desired shape and size may be lowered over and/or placed around the base product, or the desired final composition of matter, prior to or while applying the “pressurized fastening device” of desired shape and size. This method and step will be accomplished with a device hereafter referred to as a “fastening device form/sleeve.” While this step is recommended to maintain the shape of the product, it is not required to produce the final sealed composition of matter. The “indention device form/sleeve” as described in claims 8, and 10 may be similar to or identical to or similar in size and shape to the “fastening device form/sleeve” described herein claim 11.

12. A device referred to as a “pressurized fastening device” described in claim 11. A pressurized fastening device may be used by itself or in conjunction with one or more of the same for mass production. A pressurized fastening device as described herein may also be individually or in pleurality incorporated into a large, single, or multiple sheet of metal, plastic, or any other substances so as to be economically used for mass production of the final composition of matter or any portion thereof. This shall also include single or multiple sheets of trays of the same pressurized fastening devices that the base product rests in or upon which are strategically placed so the upper “pressurized fastening devices” apply the actual fastening pressure. For increased binding properties, one or both “pressurized fastening devices” should use the “displacing teeth and/or design” thereby producing a final composition of matter with distinct and novel design on one or both sides.

13. An individual device or a portion of the “pressurized fastening device” [See claim 11 and 12] referred to as “displacing teeth and/or design” as described in claim 11.

14. A device referred to as a “fastening device form/sleeve” as described in claim 11. A “fastening device form/sleeve” may be used by itself or in conjunction with one or more of the same for mass production. A “fastening device form/sleeve” as described herein may also be individually or in pleurality incorporated into a large, single, or multiple sheets of metal, plastic, or any other substance so as to be economically used for mass production of the final composition of matter or any portion thereof.

15. A method of fastening the final sealed composition of matter known as Supreme Gourmet Burger and Meatball Stuffs and Wraps, and the distinct design produced as a by-product of this method, resulting in a novel design distinct from previous attempts at preparing stuffed proteinaceous patty products. Although variations will likely occur, the final composition of matter known as Supreme Gourmet Burger Stuffs and Wraps should appear flat on predominant surfaces and/or a novel design around the outer perimeter or circumference of the final composition of matter herein and produced by the “displacing teeth and/or design” as described in claims 5 through 14, 16, and 17.

16. The distinct and novel design of the final sealed composition of matter produced by and as a direct result of the methods, other processes, and devices described in claims 1 through 15, 17 and 18.

17. The distinct and novel design of the final composition of matter produced by and as a direct result of the “displacing teeth and/or design” and/or the “pressurized fastening device” as described in claims 11 through 13 herein.

18. A method of producing the final composition of matter is to roll, wrap, and/or fold a sheet of base product over and/or around a strategically placed “food stuff” and/or “insert(s)” to form a final composition after which the various components are fastened together. This claim and other claims herein shall not infringe on any existing patent or any common item currently and continuously on the public market or in public use for a period of more than one year prior to the filing of this patent.

19. A method of producing the final composition of matter is to: shape the base product into a desired size and shape of pizza crust in place of the normal bread crust and cook as desired to form a final composition of matter after which various pizza components are placed and further cooked or otherwise prepared. This claim and other claims herein shall not infringe on any existing patent or any common item currently and continuously on the public market or in public use for a period of more than one year prior to the filing of this patent.

20. A method of producing the final composition of matter is to: shape the base product into a receptacle of desired size and shape and to cook or otherwise prepare this base product; after which various pizza components or other food stuffs are placed and, if necessary, further cooked. A large slice of pepperoni would be an ideal base product for this method and final composition of matter. This claim and other claims herein shall not infringe on any existing patent or any common item currently and continuously on the public market or in public use for a period of more than one year prior to the filing of this patent.

21. The final composition of matter referred to as “Supreme Gourmet Burger and Meatball Stuffs” and Wraps, Base Product Pizza Crust and Receptacles; and “Food Stuffs and/or Inserts” which are described and produced using the methods and processes described in claims 1 through 20 herein and/or any other method which produces the same sealed final composition of matter not previously patented. This claim and other claims herein shall not infringe on any existing patent or any common item currently and continuously on the public market or in public use for a period of more than one year prior to the filing of this patent.

22. The final composition of matter referred to as “Supreme Gourmet Base Product Pizza Crust and Receptacles” which are described in claims 1 through 21 herein and/or utilizes “food stuffs” and/or “inserts for the same or similar purposes described in claims 1 hrough 24 herein not previously patented. This claim and other claims herein shall not infringe on any existing patent or any common item currently and continuously on the public market or in public use for a period of more than one year prior to the filing of this patent.

23. The final composition of matter referred to as Supreme Gourmet Burger and Meatball “Food Stuffs” and “Inserts” which are described and produced using the methods and processes described in claims 1 through 22 herein and/or any other method which produces any “food stuffs” and/or “inserts” for the same or similar purposes described in claims 1 through 24 herein not previously patented. This claim and other claims herein shall not infringe on any existing patent or any common item currently and continuously on the public market or in public use for a period of more than one year prior to the filing of this patent.

24. SPECIFIC EXAMPLES OF PATENTED FINAL COMPOSITION OF MATTER SUPREME GOURMET BURGER AND MEATBALL STUFFS AND WRAPS; AND “FOOD STUFFS” AND/OR “INSERTS”. The following are specific examples of “food stuffs” and/or “inserts” to be placed, stuffed, or otherwise inserted into beef patties, chicken patties, turkey patties, or other proteinaceous or vegetarian patty or other “base product,” regardless of shape, including “wraps:”
Southwestern Stuff
jalapeno peppers
red peppers
bell peppers
onions
salsa
cheese [optional]
spices
Cheese Stuff
cheddar
mozzarella
other cheeses [optional]
spices
Classic Stuff
mixed chesses
onions
bell peppers
spices
Breakfast Burger Stuff
egg(s)
cheese [optional]
onions
bell peppers [optional]
bacon [optional]
ham [optional]
spices
Breakfast Sausage Stuff
egg(s)
cheese [optional]
onions
bell peppers [optional]
bacon [optional]
spices
Swiss Cheese and Mushroom Stuff
Swiss cheese
other cheeses [optional]
mushrooms
onions [optional]
bell peppers [optional]
spices
Swiss, Mushroom, and Bacon Stuff
swiss cheese
other cheeses [optional]
mushrooms
onions [optional]
bell peppers [optional]
spices
Pepperoni Pizza Stuff
pepperonis
pizza sauce
cheese [optional]
onions [optional]
spices
Supreme Pizza Stuff
pepperonis
pizza sauce
cheese [optional]
onions [optional]
spices
Bacon Cheese Stuff
bacon
cheese
spices
Pepperoni Stuff
pepperoni
cheese
spices
Sports Burger Stuff
Bacon
cheese
onions
bell peppers
spices
Dill Pickle stuff
mayonnaise
cream cheese
pickles
spices.

25. PRODUCT UTILITY:
The final composition of matter known as Supreme Gourmet Burger and Meatball Stuffs may be sold in an “As-is” state to be thoroughly cooked by the consumer and/or product user, or it may be sold in a “pre-cooked” state for quick and easy preparation by the consumer or product user. The final composition known as “food stuffs” and/or “inserts” may be sold to the consumer and/or product user to be manually stuffed and/or inserted into a base product of choice or may be restricted from sale separate from the completed products known as Supreme Gourmet Burger and Meatball Stuffs.

26. MARKETING OF PRODUCT:
This product shall be sold to a variety of customers, including but not limited to:
Fast food chains
Restaurants
Grocery stores
Schools
Sporting
Military
Concession stands
Export(ers)
Retail merchandisers
Whole sale outlets
A variety of whole sale and retail outlets
Federal agencies, departments, and government entities
Other unnamed customers.
